(19) United States
(12) Patent Application Publication
(10) Pub. No.: US 2026/0336122 A1
(43) Pub. Date: Oct. 29, 2026

(54) Method and Robotic System for 30mm Super Pull Apart Machine Autofeeding

(71) Applicant: InfoBeyond Technology LLC, Louisville, KY (US)

(72) Inventors: Fei CAO, Louisville, KY (US); Derock XIE, Louisville, KY (US)

(73) Assignee: InfoBeyond Technology LLC, Louisville, KY (US)

(21) Appl. No.: 18/772,993

(22) Filed: Jul. 15, 2024

(51) Int. Cl. B25J 9/16; B07C 5/342; F42B 33/06

(52) U.S. Cl. CPC B25J 9/1687; B07C 5/3422; B25J 9/1697; F42B 33/06; B07C 2501/0063

(57) ABSTRACT

The present invention discloses a method and system for automatically feeding the Super Pull Apart Machine (SPAM) to disassemble 30 mm rounds. It involves a sorting robot to detube and classify Depleted Uranium (DU)/non-DU rounds, depositing them into designated bins. It also involves a feeder robot to transfer DU rounds from a DU bin to a bowl feeder. Additionally, it incorporates a bowl feeder for aligning and releasing ammunition onto the chain conveyor to feed DU rounds to the SPAM at a specified feed rate. Lastly, it includes a control and management system to coordinate all components within the feed system through communication units, along with user software for operators to monitor and control the feeding process. The present invention enhances the safety of the demilitarization process by minimizing manual handling of hazardous materials, thus reducing the risk of accidents and injuries. Additionally, it reduces operational costs and increases demilitarization efficiency.

### FIELD OF THE INVENTION

The present invention pertains to an autofeeding system designed for the ammunition demilitarization process of 30 mm rounds, including a robot segregating 30 mm Depleted Uranium (DU) rounds from non-DU rounds, another robot depositing the DU rounds into a bowl feeder for alignment such that the DU rounds can be fed into a Super Pull Apart Machine (SPAM). The SPAM is responsible for extracting the projectiles for subsequent processing, such as burial or recycling. Additionally, the system incorporates control and management to oversee and regulate the entire feeding process.

### BACKGROUND OF THE INVENTION

The demilitarization and disposal of excess, obsolete, and unserviceable munitions are crucial stages in the life-cycle management of unused munitions. When munitions reach the end of their usable life, military or civilian munition depots employ various methods to dispose them, such as closed disposal technologies, open burn, or open detonation, depending on the type of munition.

The U.S. demilitarization stockpile contains over 7,000 different types of munitions. Among them is B103, which is a 30 mm combat mix that consists of two Armor Piercing Incendiary (API) rounds (PGU-14) and one High Explosive Incendiary (HEI) round (PGU-13). These B103 items are sent to demilitarization facilities in the form of linked tube carriers, secured together using fabric loops. The tube carriers contain a mixture of 30 mm rounds, including both Depleted Uranium (DU) rounds and non-DU rounds, and these rounds are identifiable by unique color codes.

Demilitarization of 30 mm rounds has several steps. At first, the ammunition packs are unpacked, the linked tubes are taken out, and then the rounds are loaded onto a cart. Subsequently, a detuber is used to remove the ammunition from the linked tubes, after which the rounds are segregated into DU and non-DU categories. Non-DU rounds are transported to be fired in the range, while DU rounds are fed into the Super Pull Apart Machine (SPAM) for disassembly.

SPAM is a closed disposal disassembly machine that reverses the assembly process and separates the projectiles. Traditionally, human operators feed 30 mm DU rounds into the SPAM's infeed individually, i.e., manually placing ammunition onto the chain conveyor connecting to the SPAM. However, this labor-intensive approach is slow and costly due to human limitations.

Additionally, it poses risks related to hazardous components, chemical exposure, and explosion hazards. Handling DU material further increases danger due to its radioactivity and toxicity, raising concerns about health risks. Moreover, the manual feeding process heightens the risk of repetitive strain injuries and accidents caused by human error, potentially damaging equipment.

### BRIEF SUMMARY OF THE INVENTION

The method presented in this invention aims at providing an automated way for feeding 30 mm DU round into the SPAM, which minimizes manual handling and processing of hazardous materials, thus reducing the risk of accidents and injuries. Additionally, it reduces the number of operators on feeding, resulting in safe and economical demilitarization of obsolete and non-serviceable munitions.

The envisioned autofeeding system aims to enable automated segregation of DU and non-DU 30 mm rounds, and feeding the ammunition into the SPAM at a specified speed (e.g., 1 round per second). On the other hand, the versatility of this method extends its applicability beyond segregating and feeding 30 mm rounds to the SPAM. The components in this system are capable of feeding munitions other than 30 mm rounds, such as 20 mm rounds.

According to the first aspect of the present invention, there is provided a method of segregating 30 mm DU rounds from non-DU rounds using a robotic system. The robotic system includes: (i) A dual-arm robot capable of handling the weight of a single 30 mm round of the heaviest type. Additionally, if it also needs to load packs of tubes onto the cart, the robot should be able to handle the total weight of the heaviest type of 30 mm round pack; (ii) A customized gripper designed to detube, pick up, rotate, hold, and release a single 30 mm round during the segregating process; (iii) A control system for managing and coordinating the various functions and movements of the robot; and (iv) A vision system for locating tubes and 30 mm rounds, classifying DU and non-DU round, monitoring the segregating process, and providing real-time feedback to ensure operational efficiency and accuracy. Additionally, the robot can be configured as a mobile platform, enhancing its versatility and adaptability for various operational environments. This mobility enables the robot to navigate autonomously within the facility, efficiently accessing different pack locations, and contributing to seamless integration with the overall ammunition feeding process.

According to the second aspect of the present invention, there is provided a method of depositing 30 mm DU rounds from bins into the bowl feeder using a robotic system. The robotic system includes: (i) A heavy-duty robot arm capable of lifting a DU bin of a specific size, fully loaded with 30 mm DU rounds of the heaviest type; (ii) A customized fork-shaped gripper designed to pick up, rotate, and securely hold a bin during the feeding process; (iii) A control system for managing and coordinating the various functions and movements of the robot; and (iv) A vision system for bin detection, alignment, positioning, process monitoring, and providing real-time feedback to ensure operational efficiency and accuracy. Additionally, the robot can be configured as a mobile platform, enhancing its versatility and adaptability for various operational environments. This mobility enables the robot to navigate autonomously within the facility, efficiently accessing different bin locations and contributing to seamless integration with the overall ammunition feeding process.

According to the third aspect of the present invention, there is provided a method of aligning and releasing 30 mm rounds to the chain conveyor at a specified feed rate using a bowl feeder. The bowl feeder includes: (i) A bowl-shaped container designed to hold and orient the ammunition in a consistent manner; (ii) An internal mechanism for manipulating the position and orientation of the ammunition within the bowl, ensuring proper alignment and presentation for feeding; (iii) A discharge assembly for transferring the aligned ammunition from the bowl feeder to the transit slide; (iv) A transit slide that aligns and orients the rounds to ensure their tips point upwards at the outlet; (v) An outlet that aligns with the chain conveyor with mechanisms to precisely drop rounds into the cups of the chain conveyor at a preset feed rate; (vi) Adjustable controls for regulating the feed rate to accommodate the status of the SPAM; and (viii) Integrated sensors and a vision system for detecting the presence or absence of 30 mm rounds at the outlet, controlling ammunition flow, synchronizing with the chain conveyor, monitoring ammunition flow, detecting jams or irregularities, and providing feedback for smooth operation. Additionally, the bowl feeder may feature additional enhancements such as anti-jamming mechanisms, gates to control the flow of ammunition, and compatibility with the chain conveyor for seamless integration into the overall ammunition handling process.

According to the fourth aspect of the present invention, a control and management system is provided to communicate with the subcontrollers at the robots, bowl feeder, and chain conveyor, facilitating monitoring and control of the feeding process. Additionally, it grants operators the ability to oversee and regulate the feeding process through user software. Data from vision systems and sensors, including status updates, are transmitted to the control and management system for analysis and adjustment, such as feed rate adjustments.

### BRIEF DESCRIPTION OF DRAWINGS

FIG. 1 is a perspective view showing the 30 mm SPAM autofeeding line of the present invention;

FIG. 2 is a perspective view of the sorting robot;

FIG. 3 a side view of the sorting robot;

FIG. 4 is a perspective view of the feeder robot;

FIG. 5 is a side view of the feeder robot;

FIG. 6 is a perspective view of the bowl feeder;

FIG. 7 is an exploded perspective view of the bowl feeder;

FIG. 8 is a plan view of the SPAM autofeeding line;

FIG. 9 is a flowchart which shows the operation of the SPAM autofeeding line in an embodiment of the present invention;

FIG. 10 is a sequence diagram of an embodiment of the present invention during normal operation;

FIG. 11 is a flowchart which shows the operation of the sorting robot;

FIG. 12 is a flowchart which shows the operation of the feeder robot;

FIG. 13 is a flowchart which shows the operation of the bowl feeder;

FIG. 14 is a flowchart which shows the operation of the chain conveyor;

FIG. 15 is a flowchart which shows the operation of the control and management system.

### DETAILED DESCRIPTION OF THE INVENTION

An embodiment in which the present invention can be used for automatically feeding the Super Pull Apart Machine (SPAM) in the demilitarization process will be described below.

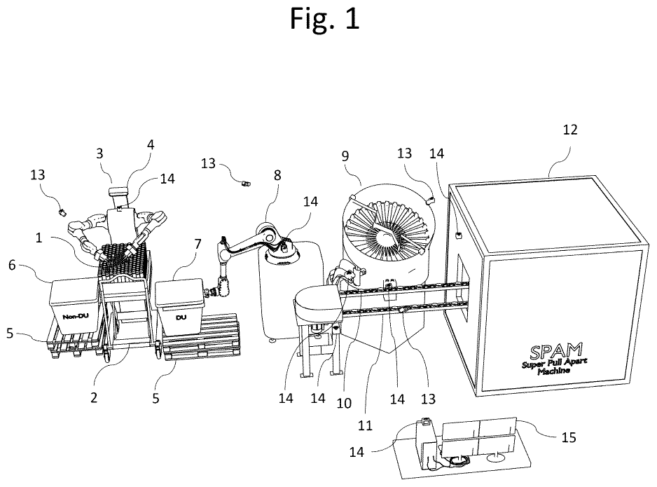

FIG. 1 shows an embodiment of feeding 30 mm DU rounds into the SPAM for disassembly. Given a loading area of the SPAM building, unboxed 30 mm rounds 1 housed within linked tubes or other containers are loaded onto a cart 2. A sorting robot 3, featuring single or multiple arms, is equipped with an integrated robot vision system 4. It is responsible for detubing the 30 mm rounds from the tubes, classifying them as DU or non-DU, and depositing them into designated bins on pallets 5. Non-DU rounds are directed to bin 6, and DU rounds are directed to bin 7. The robot vision system 4 employs Al algorithms to classify the rounds. Non-DU rounds stored in bin 6 are transported to be fired in the range, while DU rounds stored in bin 7 are fed into the SPAM for disassembly. To feed DU round into the SPAM, a heavy-duty feeder robot 8 picks up a DU bin 7 and deposits the 30 mm rounds into a bowl feeder 9. The bowl feeder 9 automatically and consistently aligns the rounds in the feeder bowl and orients rounds at the outlet with a transit slide. The end of the outlet has a tunnel that is aligned with the starting location of a cup 10 on the chain conveyor 11, which then transfers the 30 mm rounds into the SPAM 12. Non-DU bin 6 and DU bin 7 may have different capacities, especially since non-DU rounds are typically more numerous. When non-DU bin 6 reaches full capacity, it is replaced with an empty non-DU bin 6. Sorting robot 3 monitors the status of non-DU bin 6 by tracking the quantity of non-DU rounds processed since the last replacement. Once a predetermined count is reached, indicating that non-DU bin 6 is full, the replacement process initiates. The count resets once the non-DU bin 6 is replaced. Additionally, sorting robot 3 counts the number of DU rounds processed since the last pickup by feeder robot 8 to ensure that DU bin 7 is not full. Similarly, the count resets once the DU bin 7 is returned. Meanwhile, the frequency at which feeder robot 8 retrieves DU bin 7 is synchronized with its capacity and the feed rate of bowl feeder 9 to prevent overfilling and the need for replacement. Sensors and vision systems 13, along with controllers and their respective communication units 14, are integrated to monitor and manage the process flow. These components are stationed at various points including bin 6, bin 7, feeder robot 8, bowl feeder 9 and chain conveyor 11. A control and management system 15 communicates with the subcontrollers at the sorting robot 3, feeder robot 8, bowl feeder 9, and chain conveyor 11, facilitating monitoring and control of the feeding process. Additionally, it allows operators to oversee and regulate the feeding process through user software, utilizing data collected by the sensors and vision systems 13. This includes information on bin status, bowl feeder status, chain conveyor status and SPAM throughput. Subsequently, the control and management system 15 sends actuating signals to the communication units 14 of the controllers to regulate the activities of the sorting robot 3, feeder robot 8, the feed rate of bowl feeder 9, and the speed of chain conveyor 11.

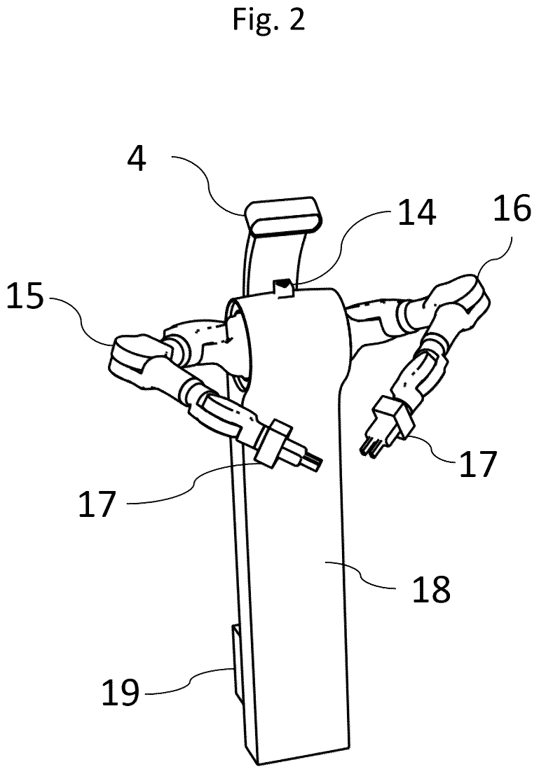

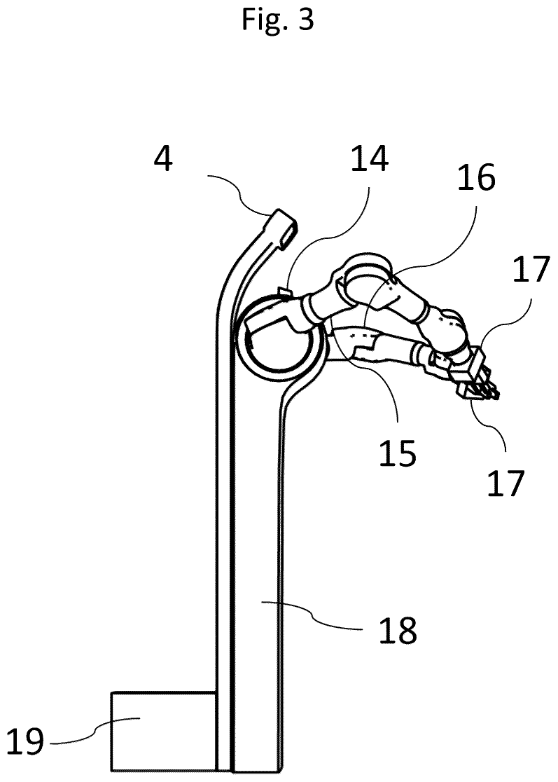

FIG. 2 shows an embodiment of the perspective view of the sorting robot 3. FIG. 3 shows an embodiment of the side view of the sorting robot 3. Sorting robot 3 is an industrial-grade, dual arm, collaborative robot with 7-axis configuration. A 7-axis robot provides seven degrees of freedom or rotational joints, enabling movement in various directions, such as vertical (up and down), horizontal (side to side), and longitudinal (forward/backward), as well as rotation around three different axes, plus an additional joint that allows the end effector to rotate independently, offering enhanced flexibility and higher precision for ammunition handling. The dual-arm configuration of the sorting robot facilitates efficient parallel processing. The collaborative nature of sorting robot 3, often referred to as a Cobot, is engineered for safe interaction with humans, enabling direct collaboration on tasks. Equipped with sensors and protective mechanisms, it minimizes the risk of injury in case of contact between the robot and operators during operation. Moreover, its ability to operate at faster speeds without compromising safety enhances operational efficiency, thereby increasing productivity and throughput in shared workspaces. Sorting robot 3 follows the ISO 8373 standard. Sorting robot 3's payload capacity (the maximum weight that a robot arm can handle while maintaining its accuracy, speed, and safety) is determined by the maximum weight of it must lift. For instance, if its task is solely to segregate 30 mm rounds, the payload capacity is at least equivalent to the weight of a single 30 mm round of the heaviest type. However, if it also needs to load packs of tubes onto the cart, the payload capacity extends to at least the total weight of the heaviest type of 30 mm round pack. Sorting robot 3's reach (the maximum distance from the base of the arm to the farthest point it can extend while still being able to perform its intended tasks accurately and safely), and physical dimensions (height, width, and depth), are determined by the distance between the sorting robot 3 and the bins, and constraints of the application environment, particularly when space is limited. Each of the sorting robot 3's arm, arm 15 and arm 16, is equipped with a customized gripper 17 to precisely pull the round out of the tube, hold for the robot vision system 4 to classify the round based on the color code of the projectile, then deposit into the designated bin. Each gripper can be equipped with a servo-controlled module for gripping and manipulating 30 mm rounds with precision control. This servo module, integral to the gripper's design, utilizes servo motors to govern the movement and positioning of the gripper's fingers or jaws, offering significant advantages over conventional pneumatic or hydraulic grippers. With servo motors, the gripper can execute precise and programmable finger movements, enabling adaptable grip force, speed, and position control. Such precision is especially valuable in applications requiring delicate handling or precise positioning of 30 mm rounds. Moreover, these grippers outfitted with servo modules integrate advanced sensory feedback systems, including force sensors or position encoders, providing real-time data on grip force and finger position. This empowers the gripper to dynamically adjust its grip in response to environmental changes or object properties, enhancing both efficiency and safety in robotic operations. In the detubing process, the gripper with a servo module proves invaluable, delicately grasping and manipulating the linked tubes containing the 30 mm rounds. The servo-controlled fingers provide precise control over grip force and position, facilitating accurate detubing without causing damage. During the classification process, the gripper's servo module allows it to securely hold and present the detubed rounds to the vision system for classification, ensuring optimal imaging and classification accuracy. Subsequently, when depositing the classified rounds into designated bins, the gripper's servo-controlled fingers ensure precise positioning and release, guaranteeing correct placement without disrupting the sorting process. Additionally, each gripper can be equipped with a vision module, further enhancing its capabilities in visual inspection or alignment. Moreover, the gripper's compliance with Electrostatic Discharge Protection (ESD) standards ensures safe handling of static-sensitive rounds. While both arms perform the same tasks of detubing and classifying 30 mm rounds as either DU or non-DU, there is a deliberate time difference in their actions. For instance, one arm 15 may start first, detube the rounds, pause to allow the vision system to classify them, and then deposit them into the designated bin. Subsequently, the other arm 16 follows a similar sequence but begins slightly later to ensure that the vision classification is not conducted simultaneously. This coordinated approach optimizes workflow and prevents potential interference between the arms during the classification process. Sorting robot 3 tracks the quantity of both DU and non-DU rounds processed since the replacement of bin 6 and the pickup and emptying of bin 7 by feeder robot 8. Predetermined thresholds are set to determine when bin 6 or 7 reaches full capacity, particularly if they differ in size. Meanwhile, Sorting robot 3 is controlled by an embedded robot system controller, which controls the robot arms and grippers by using industrial communication protocols. The coordinated control system integrates various components such as sensors, actuators, and controllers to ensure smooth operation of the robot. Communication protocols facilitate coordination between the robot and other system components such as the bowl feeder 9, and chain conveyor 11. Feedback loops allow the system to adjust robot movements based on real-time data from sensors and external signals. The control system ensures synchronization of robot activities with other system components to achieve the desired feeding process efficiently and accurately. This controller is housed within the controller cabinet 18, where it coordinates the sorting robot 3's movements and functionalities. The controller encompasses a motion controller, along with internal and external communication units 14, and potential power stages. The internal communication unit facilitates data exchange between different modules within sorting robot 3, ensuring effective coordination of activities among its components. The external communication unit enables sorting robot 3 to transmit status updates and receive commands from the control and management system 15. Additionally, sorting robot 3 can be equipped with an Automated Guided Vehicle (AGV) system 19, a mobile platform with wheels that enables autonomous navigation and ammunition pack loading within its environment, eliminating the need for an operator to load the pack of tubes onto the cart.

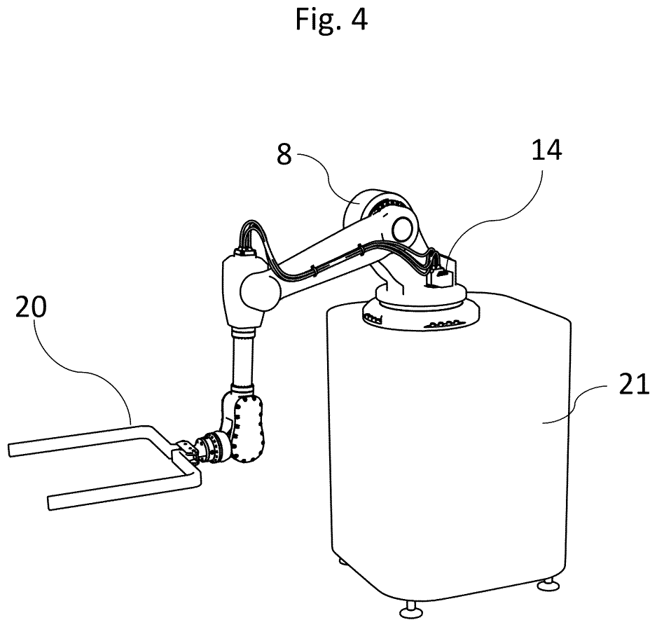

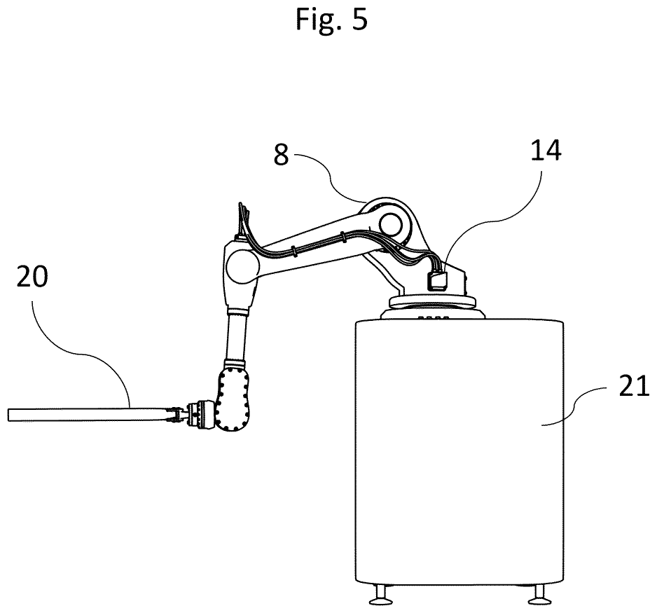

FIG. 4 shows an embodiment of the perspective view of the feeder robot 8. FIG. 5 shows an embodiment of the side view of the feeder robot 3. Feeder robot 8 can be an industrial-grade collaborative robot with either 6-axis or 7-axis configurations. A 6-axis robot provides six degrees of freedom or rotational joints, enabling movement in various directions, such as vertical (up and down), horizontal (side to side), and longitudinal (forward/backward), as well as rotation around three different axes. Conversely, a 7-axis robot features an additional joint that allows the end effector to rotate independently, offering enhanced flexibility and higher precision for ammunition bin handling. Feeder robot 8 follows the ISO 8373 standard. Feeder robot 8's payload capacity (the maximum weight that a robot arm can handle while maintaining its accuracy, speed, and safety) is determined by the maximum weight of bin 7 when fully loaded with ammunition. Feeder robot 8's reach (the maximum distance from the base of the arm to the farthest point it can extend while still being able to perform its intended tasks accurately and safely) and physical dimensions (height, width, and depth) are determined by several factors. These include the distance between Feeder robot 8 and the DU bin 7 and bowl feeder 9, as well as the constraints of the application environment, particularly when space is limited. Feeder robot 8 is equipped with a fork-shaped gripper 20, which is an end effector connected on the feeder robot 8, to pick up bin 7, and deposit the ammunition into the bowl feeder 9. Feeder robot 8 is controlled by an embedded robot system controller, which controls the robot arm and the gripper 20 by using industrial communication protocols. The coordinated control system integrates various components such as sensors, actuators, and controllers to ensure smooth operation of the robot. Communication protocols facilitate coordination between the robot and other system components such as the bowl feeder 9, and chain conveyor 11. Feedback loops allow the system to adjust robot movements based on real-time data from sensors and external signals. The control system ensures synchronization of robot activities with other system components to achieve the desired feeding process efficiently and accurately. This controller is housed within the controller cabinet 21, where it coordinates the feeder robot 8's movements and functionalities. The controller encompasses a motion controller, along with internal and external communication units 14, and potential power stages. The internal communication unit facilitates data exchange between different modules within feeder robot 8, ensuring effective coordination of activities among its components. The external communication unit enables feeder robot 8 to transmit status updates and receive commands from the control and management system 15. Additionally, feeder robot 8 can be equipped with an Automated Guided Vehicle (AGV) system, a mobile platform with wheels that enables autonomous navigation and ammunition bin picking within its environment, eliminating the need for an operator to position the bin in a fixed location.

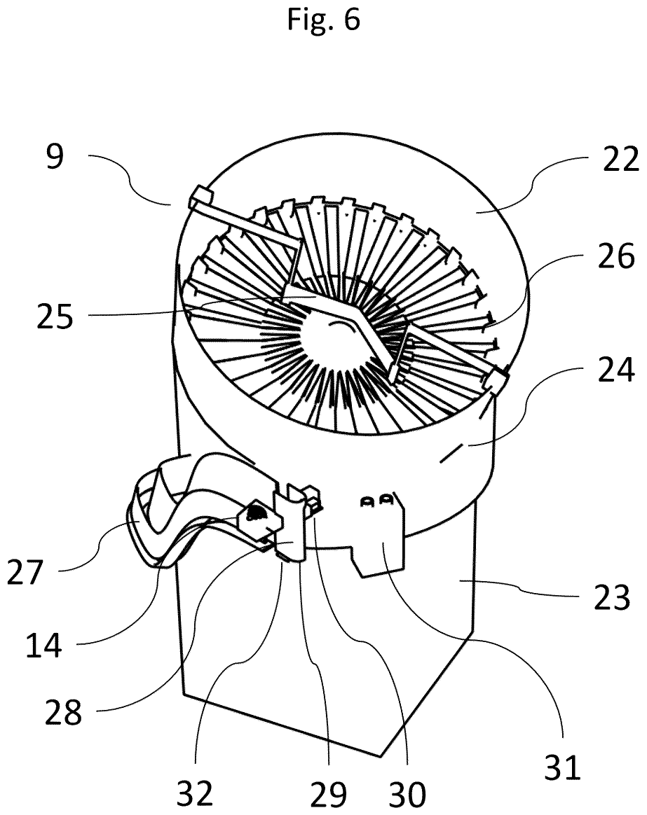

FIG. 6 shows an embodiment of the perspective view of the bowl feeder 9. The bowl feeder 9 adapted for feeding 30 mm rounds to the chain conveyor is designed to sort, orient, and feed efficiently and accurately. The bowl feeder is a centrifugal bowl feeder to accommodate factors such as the large ammunition dimensions and weight of the 30 mm rounds, a feeding speed of 1 round per second, and precise orientation control to ensure the rounds are positioned with their tips pointing upward. A centrifugal feeder for feeding ammunition consists of a circular feeder bowl with a spiral track inside, mounted on a base. The bowl is typically made of durable materials such as stainless steel to withstand the weight and impact of ammunition. Ammunition parts are loaded into the bowl, where they accumulate randomly. The bowl rotates, generating centrifugal force that pushes the ammunition towards the outer edge of the bowl. Along the spiral track, there are features or mechanisms designed to orient the ammunition in a specific direction. These features ensure that the ammunition are correctly positioned for downstream processing. Once oriented, the ammunition reach the outer edge of the bowl and are discharged one by one. Centrifugal bowl feeders are favored for larger and heavier ammunition, offering higher feeding speeds. For this embodiment, a centrifugal bowl feeder is selected, with a size of at least 30 inches to meet the desired feeding speed. Customization options are available for the bowl feeder size to adapt to specific application needs, including feed rate adjustments. The bowl feeder wall 22 is constructed from stainless steel to ensure durability and corrosion resistance. The bowl feeder 9 is mounted to a custom height base stand 23 via a bowl feeder stand 24, providing flexibility for adjusting discharge height. The bowl feeder motor is located within the feeder stand 24, as it provides the necessary support and stability for the motor while also allowing for easy access and maintenance. During operation, the bowl feeder 9 rotates, utilizing centrifugal force and sweep arm 25 to guide 30 mm rounds into the slots of the feeder wheel 26. Rounds within the slots are discharged from the bowl to a transit slide 27 integrated with the bowl feeder stand 24. The transit slide 27 is custom-designed to sort and orient the rounds to ensure their tips point upwards at the outlet 28. The outlet 28 features a U-shape tailored to fit 30 mm rounds, preventing them from falling out. At the bottom of the outlet 28 is a tunnel 29 that is aligned with the starting location of a cup on the chain conveyor 11. During feeding, when the 30 mm round reaches the end of the outlet 28, it automatically drops into the cup through the tunnel 29. The design of the bowl feeder 9, including factors such as its size, shape, and orientation mechanisms, along with considerations like the bowl size, rotational speed, and the structure of the transit slide 27, ensures that the feeding rate precisely aligns with the speed of the chain conveyor 11. Additionally, a sensor 30 is installed at the outlet 28 to detect the presence or absence of 30 mm rounds without physical contact. This sensor, either a proximity or optical type, operates based on specific principles. In the embodiment, an inductive proximity sensor generates an electromagnetic field and detects disruptions caused by rounds. Alternatively, a photoelectric sensor emits a light beam and detects interruptions caused by rounds. When a 30 mm round enters the detection range of the sensor 30, it triggers the sensor to send a signal to the bowl feeder controller 31, indicating the presence of the 30 mm round. This signal enables synchronization with the chain conveyor 11. A gate 32 is integrated at the outlet 28 to regulate the feeding flow of 30 mm rounds. It opens to release ammunition and closes when a stop control signal is received. The bowl feeder controller 31 regulates the operation of the bowl feeder, receiving actuating signals from the control and management system 15 through communication unit 14. It controls functions such as starting and stopping the bowl feeder, adjusting feeding speed, controlling the gate, pausing in case of congestion detected by the vision system 13 stationed at the bowl feeder, or executing emergency stops when necessary.

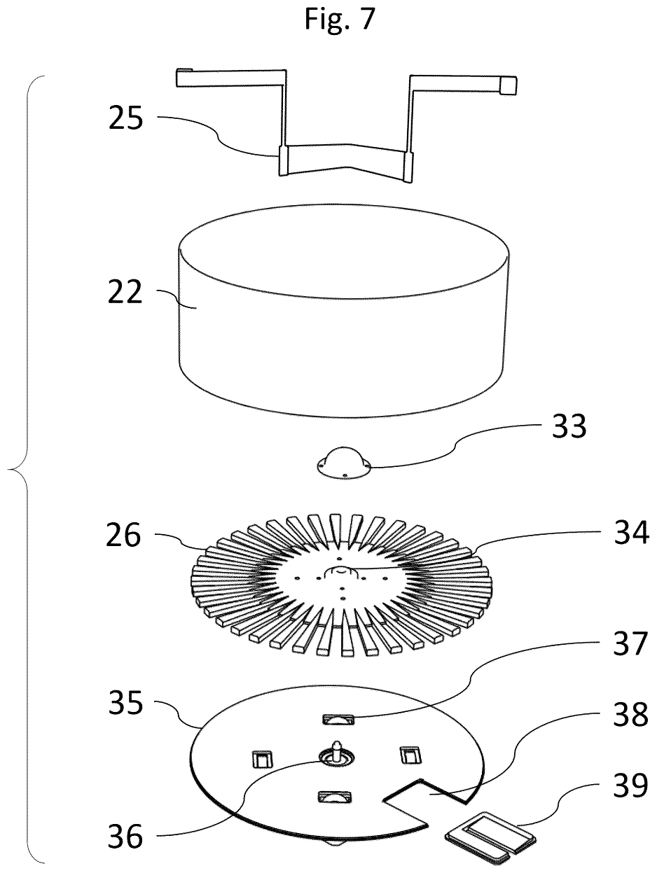

FIG. 7 shows an embodiment of the exploded perspective view of the bowl feeder 9. Inside the bowl feeder, the clutch mechanism controls the rotation of the feeder bowl. A clutch cover 33 is used to protect the clutch mechanism by shielding the clutch from dust, debris, and other contaminants that could potentially affect its performance or cause damage. Additionally, it enhances safety of operators and maintenance personnel by preventing accidental contact with the moving parts of the clutch mechanism. A feeder wheel 26 and a friction clutch 34 is always attached. The feeder wheel 26 is responsible for transporting ammunition from the feeder bowl to the discharge assembly. It consists of a rotating disc with slots and grooves to accommodate and move the ammunition along its surface. The feeder wheel 26 ensures that 30 mm rounds are evenly distributed and oriented as they move towards the discharge assembly. The friction clutch 34 controls the rotation of the feeder wheel 26. It allows for the engagement and disengagement of the feeder wheel 26's rotation mechanism. When engaged, the clutch enables the rotation of the feeder wheel, allowing it to transport ammunition from the feeder bowl to the discharge assembly. When disengaged, the clutch interrupts the rotation of the feeder wheel 26, halting the feeding process. A sweep arm 25 is affixed to the feeder wheel 26, responsible for controlling the height of the ammunition as they traverse the wheel's surface. It ensures that properly oriented ammunition proceeds along the feeding track, while any misaligned or improperly positioned rounds are swept away. The feeder wheel 26 is mounted on a base plate 35, which incorporates shim 36, roller bearings 37, and blank assembly 38 for installing the discharge 39. The discharge 39 is dimensioned to accommodate the size of the 30 mm rounds and functions as the outlet through which ammunition is discharged from the bowl feeder to the downstream assembly.

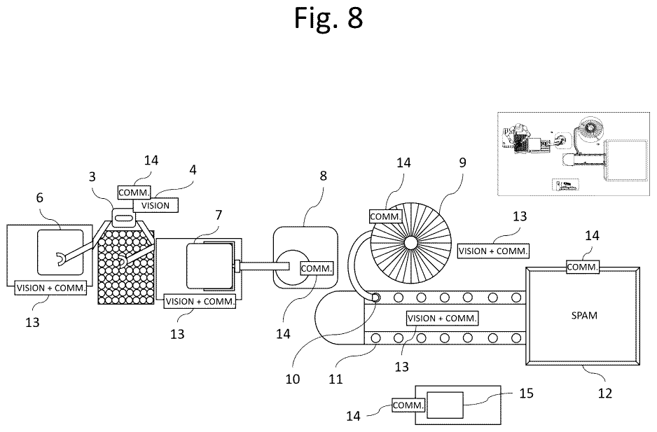

In this embodiment of the 30 mm SPAM line, ammunition feeding flow proceeds in one direction. FIG. 8 shows an embodiment of the invention in a plan view. Within the loading area of the SPAM building, once a pack of 30 mm round tubes is loaded onto the cart, the sorting robot 3 undertakes various tasks. These include detubing 30 mm rounds from the tubes, classifying them as DU or non-DU, and depositing non-DU rounds into bin 6 and DU rounds into bin 7. The sorting robot 3 continues this process until all tubes are emptied, as detected by its robot vision system 4. At this point, either an operator removes the existing pack of tubes and loads another onto the cart, or the sorting robot 3 performs the task if it is equipped with AGV. This cycle repeats until no more packs of tubes remain in the SPAM building. During feeding, the sorting robot 3 pauses its operation when the feeder robot 8 picks up bin 7, as well as when bin 6 reaches its full capacity. Since non-DU rounds are more abundant, bin 6 tends to fill faster than bin 7, particularly if they share the same size, necessitating synchronized actions to enhance efficiency. To achieve this, the sorting robot 3 is synchronized with both the pickup frequency of the feeder robot 8 and the frequency of replacing a full bin 6 with an empty one. If equipped with an AGV for mobility, the sorting robot 3 can also be tasked with handling the replacement of bin 6, eliminating the need for human intervention. The status of the bins is continuously monitored by vision systems 13 stationed at the loading area, which relay information to the control and management system 15 through the communication unit. Control over the timing of each pause lies with the control and management system 15, which sends commands to the sorting robot 3 via its communication unit 14. The feeder robot 8 consistently retrieves bin 7, depositing ammunition into the bowl feeder 9 until bin 7 is emptied. The bin status is monitored by the vision system 13 stationed at the bowl feeder that communicates with the control and management system 15 via its communication unit 14. Control over the timing of each pickup and deposit lies with the control and management system 15, which sends commands to feeder robot 8 via its communication unit 14. Subsequently, the bowl feeder 9 automatically aligns and releases 30 mm rounds onto the first cup 10 of the chain conveyor 11. Vision systems 13 stationed at the feeding area continuously monitor the status of the bowl feeder 9 and the chain conveyor 11, relaying updates such as misalignment alerts to the control and management system 15. In response, the system sends commands to the communication units 14 at the bowl feeder 9, and chain conveyor 11 to guide their activities. Additionally, the communication unit 14 at the SPAM 12 transmits SPAM status updates to the control and management system 15 for further action.

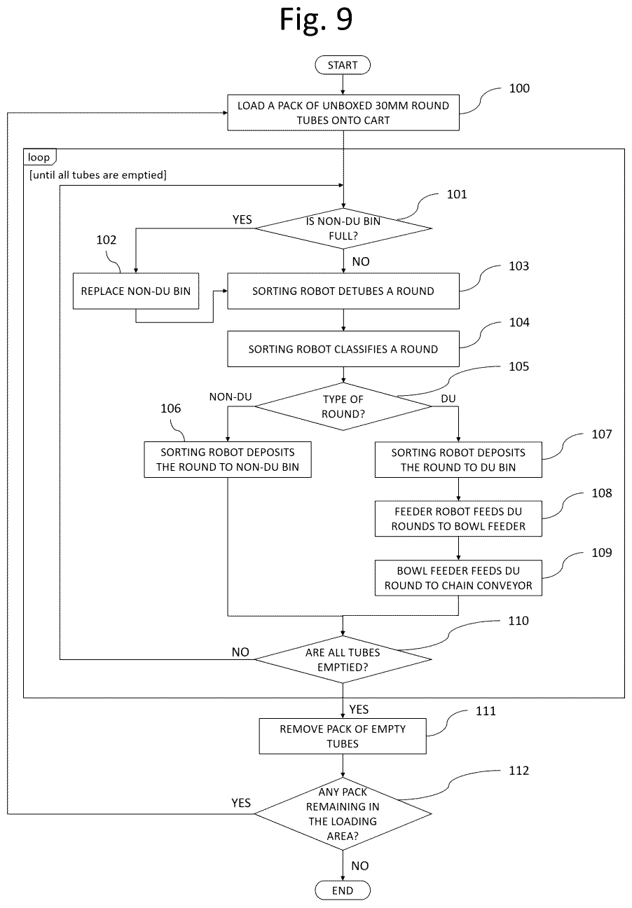

FIG. 9 illustrates an embodiment of a flowchart depicting the autofeeding procedure of the SPAM line. At the beginning of the feeding process (step 100), 30 mm round packages are unboxed, and a pack of linked tubes containing 30 mm rounds is loaded onto the cart by either the operator or the sorting robot 3. The subsequent steps continue in a loop until all tubes in the cart are emptied. In step 101, the vision system 13 stationed at the loading area inspects the non-DU bin 7 to determine if it is full. If the bin is full, the operator or sorting robot 3 replaces the non-DU bin 7 with an empty one (step 102). Otherwise, sorting robot 3 proceeds to detube a round (step 103) and classify it as DU or non-DU (step 104). It utilizes its robot vision system with image classification Al algorithms to ascertain the type of round (step 105). If identified as non-DU, the round is deposited into the non-DU bin 6 (step 106); if DU, it is deposited into the DU bin 7 (step 107). Periodically, as per a preset pickup frequency, the feeder robot 8 retrieves the DU bin 7, empties its rounds into the bowl feeder 9, and then returns the DU bin 7 (step 108). Meanwhile, the bowl feeder continues to feed DU rounds to the chain conveyor 11 (step 109). The sorting robot 3 processes the tubes row by row until it reaches the last tube. In step 110, the robot vision system 4 checks if all tubes are emptied. If not, it loops back to step 101 to process the next round. If all tubes are emptied, either the operator or the sorting robot 3 removes the pack of empty tubes (step 111). Subsequently, the vision system 13 stationed at the loading area checks if there are any packs of tubes left for processing (step 112). If affirmative, it returns to step 100 to load the next pack of tubes; otherwise, if no packs remain, the feeding process concludes when the bowl feeder 9 is empty, as reported by the vision system 13 stationed at the bowl feeder 9.

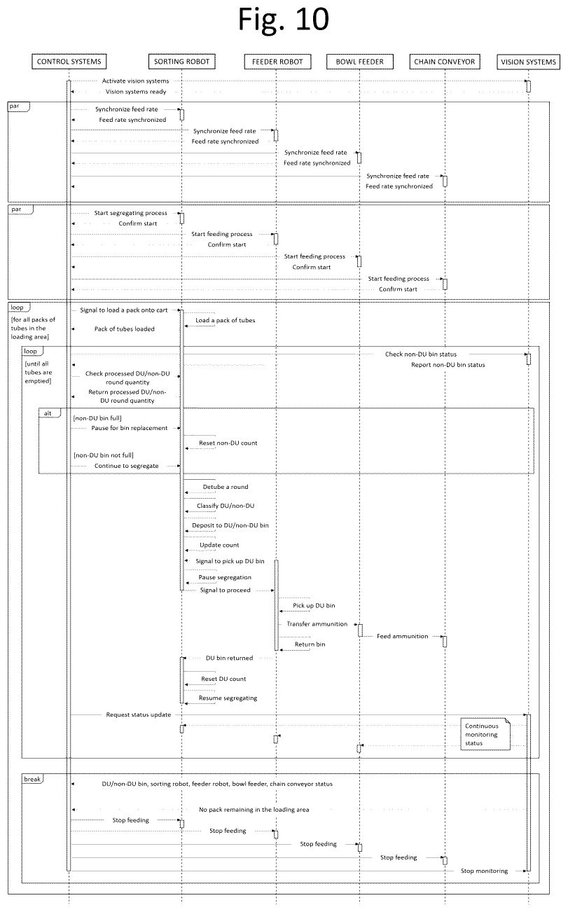

FIG. 10 illustrates an embodiment of a sequence diagram showing the communication and interactions between six components involved in the feeding process: control systems, including control and management system 15 and subcontrollers at sorting robot 3, feeder robot 8, bowl feeder 9, chain conveyor 11, and vision systems 13. The process initiates with the control and management system 15 sending a control signal to activate the vision systems. Once activated, the vision systems respond with a “vision system ready” message. Subsequently, the control and management system 15 sends messages to sorting robot 3, feeder robot 8, bowl feeder 9, and chain conveyor 11 to synchronize the feed rate, with each component confirming synchronization. Following this, parallel processes occur: the control and management system 15 sends control signals to sorting robot 3 to initiate the DU/non-DU segregating process, and to feeder robot 8, bowl feeder 9, and chain conveyor 11 to start feeding. Each component confirms readiness to start. Within a loop for all unboxed packs of tubes containing 30 mm rounds in the loading area, the control and management system 15 instructs sorting robot 3 to load a pack of tubes onto the cart. Sorting robot 3 locates and loads a pack of tubes and acknowledges with a “Pack of tubes loaded” message. Inside this loop, another loop processes the loaded pack of tubes until all tubes are emptied. Initially, the control and management system 15 signals the vision system 13 stationed in the loading area to check the status of non-DU bin 6 to determine if it is full. The vision system 13 reports the non-DU bin 6's status to the control and management system 15. Concurrently, the control and management system 15 signals sorting robot 3 to check the quantities of DU/non-DU rounds processed since the last reset, respectively, to ensure that non-DU bin 6 and DU bin 7 are not full. Sorting robot 3 returns the quantities of DU/non-DU rounds processed since the last reset, respectively. Next, an alternative step occurs: if non-DU bin 6 is full, the control and management system 15 signals sorting robot 3 to pause for bin replacement. After replacement, sorting robot 3 resets its count on non-DU rounds. Alternatively, if non-DU bin 6 is not full, the control and management system 15 instructs sorting robot 3 to continue segregating. This process involves detubing a 30 mm round from the tube, using the robot vision system 4 to classify it as DU or non-DU, depositing the round into the designated bin, and updating the DU/non-DU count. When it is time for feeder robot 8 to pick up the DU bin to feed the bowl feeder 9, it informs sorting robot 3 about the pickup. Sorting robot 3 pauses its segregation process, signals feeder robot 8 to proceed with pickup, and then feeder robot 8 picks up DU bin 7. Once picked up, feeder robot 8 transfers the DU rounds to bowl feeder 9, returns DU bin 7 to the loading area, and notifies sorting robot 3 that DU bin 7 has returned. Upon receiving the notification, sorting robot 3 resets the DU round count to 0 and resumes segregating. Throughout the process, the control and management system 15 requests status updates from vision systems 13 stationed at different locations, and the vision systems 13 reply with the status. The loop continues until the vision system 13 at the loading area reports that no packs remain. Subsequently, the control and management system 15 sends messages/control signals to stop feeding and monitoring to sorting robot 3, feeder robot 8, bowl feeder 9, chain conveyor 11, and vision systems 13, respectively.

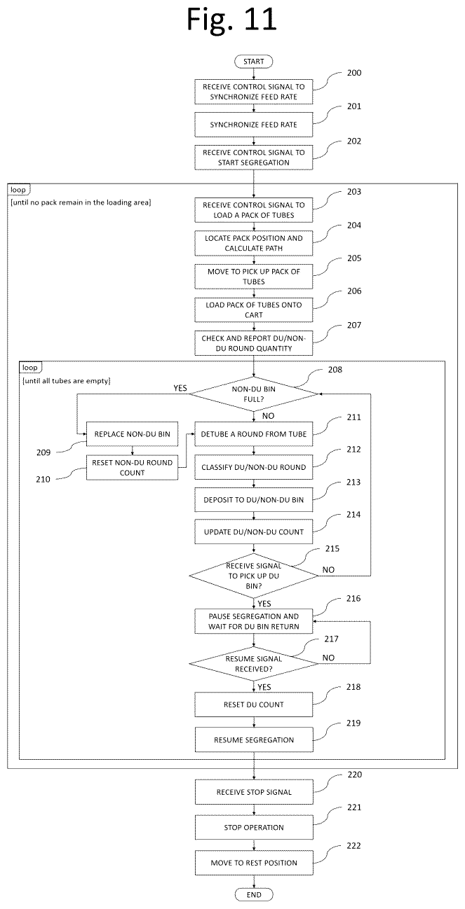

FIG. 11 illustrates an embodiment of a flowchart depicting the operation of the sorting robot 3 during the feeding process. Upon receiving the control signal from the control and management system 15 to synchronize the feed rate (step 200), sorting robot 3 aligns its feed rate with the other components in the feed system (step 201). Upon receiving the control signal to initiate segregation (step 202), sorting robot 3 begins the segregating process. This sequence continues until no more packs of tubes are left in the loading area. The process begins with sorting robot 3 receiving the control signal to load a pack of tubes onto the cart (step 203). Subsequently, sorting robot 3 scans the pickup location in the loading area to locate the pack's position and calculates the optimal path for pickup (step 204). If configured as a mobile robot, it moves to the pack's location, activates the gripper mechanism, and picks it up (step 205). In step 206, sorting robot 3 coordinates both robot arms to pick up the pack of tubes, locate the position of the cart, and load the pack onto the cart. Next, sorting robot 3 checks the quantity of DU and non-DU rounds it has processed after the latest resets, respectively, and reports to the control and management system 15 (step 207). A loop then repeats until all tubes are emptied. In this loop, the vision system 13 stationed at the loading area checks if the non-DU bin is full (step 208). If it is full based on the vision system 13's result and the count of non-DU rounds reported by the sorting robot 3, the non-DU bin is replaced (step 209), and sorting robot 3 resets its non-DU round count (step 210). Following this, sorting robot 3 begins segregating the 30 mm rounds one by one. It detubes a round from the tube (step 211), uses its AI-based robot vision system 4 to classify DU/non-DU (step 212), and deposits it into the designated bin (step 213). The DU or non-DU count is updated accordingly (step 214). During the segregating process, the feeder robot 8 periodically retrieves the DU bin 7 according to the preset schedule. Before moving to pick up the DU bin 7, it sends a notification signal to the sorting robot 3. Upon receiving the signal (step 215), sorting robot 3 pauses the segregation process and waits until DU bin 7 returns and a resume segregation signal is received (step 216). Upon receiving the resume segregation signal (step 217), sorting robot 3 resets the DU count (step 218) and resumes segregation (step 219). Steps 208 to 219 are repeated until all tubes are emptied. Finally, the vision system 13 stationed at the loading area checks if there are any packs left in the loading area. If yes, sorting robot 3 returns to step 203 to segregate the next pack. If no, the control and management system 15 sends a stop signal to the feed system. Upon receiving the stop signal (step 220), sorting robot 3 stops operation (step 221), and transitions to the rest position (step 222).

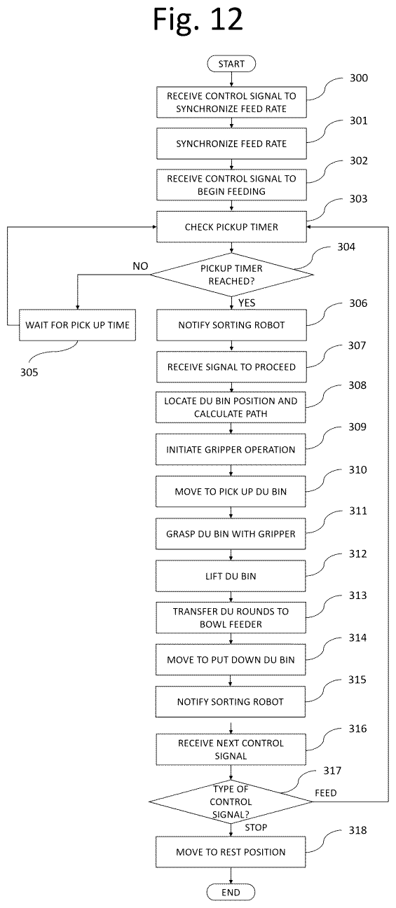

FIG. 12 illustrates an embodiment of a flowchart showing the operation of the feeder robot 8 during the feeding process. Upon receiving the control signal from the control and management system 15 to synchronize the feed rate (step 300), feeder robot 8 aligns its feed rate with the other components in the feed system (step 301). Following this, upon receiving the control signal to begin feeding (step 302), feeder robot 8 initiates the feeding process. It continuously monitors the preset pickup timer (step 303) to determine if it is time to pick up the DU bin (step 304). If the pickup timer has not been reached, feeder robot 8 remains in a waiting state until the designated pickup time (step 305). Once the pickup timer is reached, feeder robot 8 first sends a signal to notify the sorting robot 8 about the pickup (step 308). It then awaits confirmation from the sorting robot 3, ensuring that segregation has been paused and it's safe to proceed with the pickup (step 308). Upon receiving the proceed signal, feeder robot 8 scans the pickup location in the loading area to locate the DU bin and calculates the optimal path for pickup (step 308). Subsequently, it activates the gripper mechanism in preparation for bin pickup (step 309). The robot arm then moves to the calculated position of the DU bin for pickup according to the calculated path (step 310). Using the fork-shaped gripper, feeder robot 8 securely grasps the DU bin (step 311) and lifts it from its position in the loading area (step 312). The DU rounds are then transferred from the DU bin to the bowl feeder 9 for further processing (step 313). After one round of feeding, the robot arm returns to put down the bin (step 314) and notifies sorting robot 3 that the DU bin has been returned and segregation can resume (step 315). Feeder robot 8 then awaits the next control signal to determine the subsequent action. Upon receipt of the next control signal from the control and management system 15 (step 316), feeder robot 8 verifies the type of control signal received (step 317). If it's a feed signal, feeder robot 8 returns to step 303 to prepare for the next bin pickup. If it's a stop signal, feeder robot 8 completes its tasks and transitions to the rest position (step 318).

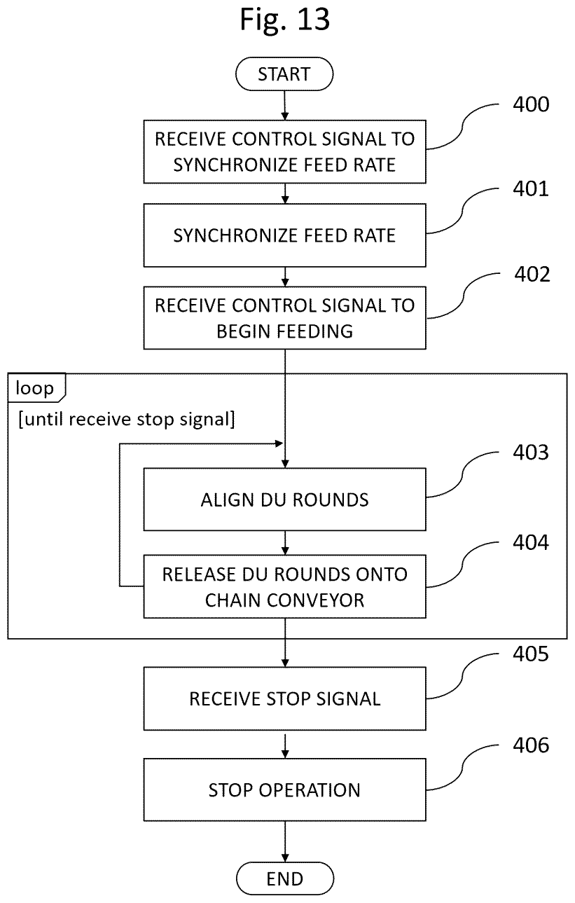

FIG. 13 illustrates an embodiment of a flowchart showing the operation of the bowl feeder 9 during the feeding process. Upon receiving the control signal from the control and management system 15 to synchronize the feed rate (step 400), bowl feeder 9 aligns its feed rate with the other components in the feed system (step 401). Upon receiving the control signal from the control and management system 15 to begin feeding (step 402), bowl feeder 9 starts the feeding process. It rotates to align the DU rounds properly within the bowl feeder (step 403). Utilizing the vision system 13 stationed at the bowl feeder 9 and bowl feeder controls, it verifies that the DU rounds are correctly aligned before discharge. Then, it releases the rounds onto the chain conveyor 11 one by one for further processing (step 404). A gate 32 at the outlet 28 regulates the feeding flow of 30 mm rounds based on the bowl feeder controller 31's control signals. Bowl feeder 9 continues feeding until a stop signal is received (step 405), at which point it stops operation (step 406).

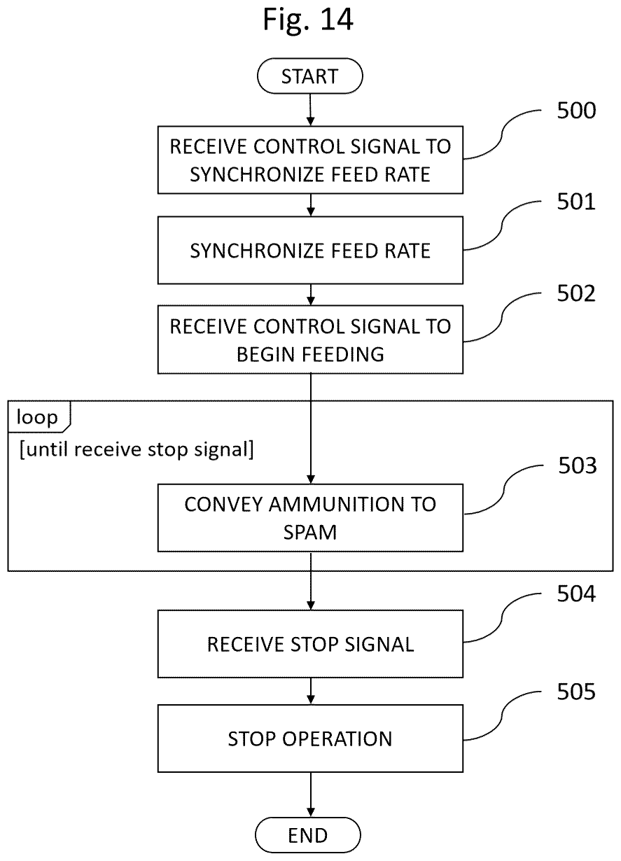

FIG. 14 illustrates an embodiment of a flowchart showing the operation of the chain conveyor 11 during the feeding process. Upon receiving the control signal from the control and management system 15 to synchronize the feed rate (step 500), chain conveyor 11 aligns its feed rate with the other components in the feed system (step 501). Upon receiving the control signal from the control and management system 15 to begin feeding (step 502), chain conveyor 11 initiates the feeding process. It keeps running at a constant speed and receiving 30 mm DU rounds from the bowl feeder 9. Subsequently, the conveyor belt transports the rounds to SPAM for separation (step 503). Chain conveyor 11 continues operating until a stop signal is received (step 504), at which point it stops operation (step 505).

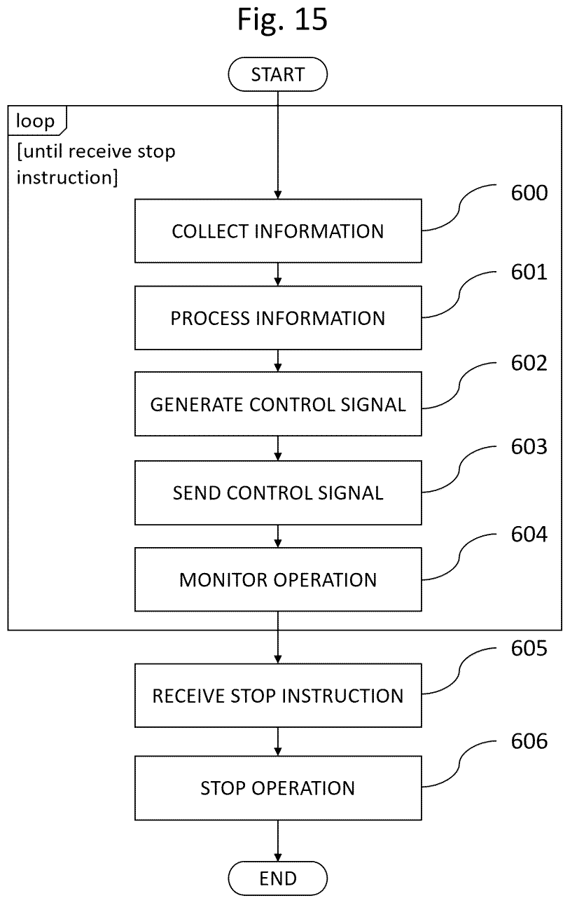

FIG. 15 illustrates an embodiment of a flowchart showing the operation of the control system during the feeding process. Firstly, the control and management system 15 initializes and prepares to start operation. It collects information, including status updates, from various vision systems 13 and subcontrollers at sorting robot 3, feeder robot 8, bowl feeder 9, chain conveyor 11, and SPAM 12 (step 600). The received signals are processed to determine the appropriate action to take (step 601). Based on the processed signals, control and management system 15 generates control signals to actuate various components of the system (step 602). These control signals are then sent to the respective actuators, motors, and other devices to execute the desired actions (step 603). Throughout the entire feeding process, control and management system 15 continuously monitors the operation of the system to ensure it functions correctly and safely, leveraging the information received from the vision systems 13 (step 604). The system continues to run until instructed by the operator to stop (step 605), at which point it stops operation (step 606).

A person skilled in the art should understand that the embodiments of this invention may be provided as a method, a system, or a computer program product. These embodiments can take the form of software-only, hardware-only, or a combination of software and hardware implementations. The invention may utilize one or more computer programs, which are implemented in computer-readable memory and/or storage media containing executable program codes.

The embodiments of the invention are described with reference to block diagrams, flowcharts, and/or message sequence charts representing the method, system, and computer program product according to this application. It should be understood that computer program instructions may be used to implement each step and/or block in these flowcharts, block diagrams, and message sequence charts. These computer program codes and/or instructions can be implemented in computing devices, including general-purpose or dedicated computers, microprocessors, chips, or processors of any other programmable data processing device. The embodiments of the invention may be realized as program codes and/or instructions executable on a computer, processor, or any other programmable data processing device, creating an apparatus for implementing specific functions within one or more processors in the flowcharts, message sequence charts, and/or the blocks in the block diagrams.

The computer program instructions may be stored in a computer-readable memory, which can guide the computer or any other programmable data processing device to operate in a specific manner. These instructions stored in the computer-readable memory generate an artifact that includes an instruction apparatus. The instruction apparatus implements a specific function within one or more processes in the flowcharts, message sequence charts, and/or one or more blocks in the block diagrams.

The computer program instructions can be loaded onto a computer or another programmable data processing device. This allows a series of operations and steps to be performed, resulting in computer-implemented processing. The executed instructions on the computer or other programmable device provide steps for implementing a specific function within one or more processes in the flowcharts, message sequence charts, and/or one or more blocks in the block diagrams.

A person skilled in the art can make various modifications and variations to the embodiments of the invention without departing from the scope of this invention. This invention is intended to cover such modifications and variations, provided they fall within the protection defined by the following claims and their equivalent technologies.

1. A Super Pull Apart Machine (SPAM) autofeeding system to automatically feed 30 mm ammunition into the SPAM for demilitarizing, comprising:
a) a sorting robotic system equipped with vision system and sensors for
i) detubing 30 mm rounds from linked tubes;
ii) segregating Depleted Uranium (DU) and non-DU 30 mm rounds in real-time, utilizing advanced Al classification algorithms trained with the unique shape, size, and color codes of 30 mm rounds;
iii) depositing DU rounds into DU bin, and non-DU rounds into non-DU bin.
b) a feeder robotic system equipped with vision system and sensors for transferring ammunition from DU bin into the bowl feeder using a customized gripper for secure handling;
c) a bowl feeder for aligning and releasing 30 mm DU rounds into the cups of the chain conveyor at a preset feed rate, and providing real-time status updates to the control and management system, featuring:
i) a clutch mechanism for controlling the rotation of the feeder wheel;
ii) a feeder wheel designed to efficiently guide and orient 30 mm rounds within the feeder bowl;
iii) a sweep arm for ensuring uniform distribution of 30 mm rounds along the feeder wheel;
iv) a discharge assembly to facilitate the smooth release 30 mm rounds from the feeder bowl to the transit slide;
v) a custom-designed transit slide to sort and orient the 30 mm rounds to ensure their tips point upwards at the outlet;
vi) a custom-designed outlet that securely transfers 30 mm rounds from the transit slide to the cups on the chain conveyor;
vii) customizable bowl geometry and adjustable settings to adapt to specific application needs, including feed rate adjustments;
viii) integrated sensors for monitoring ammunition levels, detecting jams, and providing feedback to the control and management system.
d) a control and management system coordinating all components within the SPAM autofeeding system throughout the entire feeding process, including monitoring the status of each component, adjusting parameters based on real-time data from vision systems and sensors, managing feeding schedules, and providing comprehensive reporting capabilities. This system enables operators to monitor and regulate the process using user-friendly software, allowing for seamless control and optimization of the entire ammunition feeding process within the SPAM.

2. An automated method, as set forth in claim 1, for detubing 30 mm rounds from linked tubes, classifying DU and non-DU rounds, and depositing them into DU and non-DU bins using a sorting robot equipped with a vision system, comprising the steps of:
a) locating the position of linked tubes and rounds;
b) detubing the rounds from the linked tubes one by one;
c) classifying the type of round as DU or non-DU using the AI-based vision system;
d) depositing DU rounds into the DU bin and non-DU rounds into the non-DU bin;
e) resetting the DU count after replacing a full DU bin with an empty one;
f) resetting the non-DU count after each feeder robot pick;
g) counting the number of DU and non-DU rounds since resetting the count;
h) updating status to the control and management system and receiving control signals to synchronize with the feed process.

3. An automated method, as set forth in claim 1, for depositing ammunition from DU bins into the bowl feeder massively using a feeder robot equipped with a vision system, comprising the steps of:
a) locating the position of DU bin using the vision system;
b) gripping DU bin and transferring ammunition from the DU bin to the bowl feeder;
c) updating status to the control and management system and receiving control signals to synchronize with the feed process.

4. An automated method, as set forth in claim 1, for aligning and releasing 30 mm DU rounds into the cups of the chain conveyor at a preset feed rate using a bowl feeder, comprising the steps of:
a) receiving ammunition from the robot to the bowl feeder;
b) aligning and orienting ammunition within the feeder bowl;
c) transferring the aligned rounds from the bowl feeder to the transit slide;
d) aligning and orienting the rounds on the transit slide to ensure their tips point upwards at the outlet;
e) precisely dropping the aligned rounds into the cups of the chain conveyor at the preset feed rate;
f) adjusting the feed rate to accommodate the status of the SPAM;
g) detecting the presence or absence of 30 mm DU rounds at the outlet using integrated sensors and a vision system;
h) monitoring ammunition flow and detecting jams or irregularities using vision system and sensors to ensure consistent and controlled ammunition flow;
i) updating status to the control and management system and receiving control signals to synchronize with the feed process.

5. A control and management system, as set forth in claim 1, coordinates all components throughout the entire feeding process and allows operators to monitor and regulate the process using user software, comprising:
a) communication with subcontrollers at the sorting robot, feeder robot, bowl feeder, chain conveyor, and SPAM;
b) monitoring ammunition flow, status, and process parameters based on visual and sensor data from multiple locations;
c) adjusting feed rate and system parameters as needed;
d) providing user interface for real-time monitoring and control.

6. A network of vision systems according to claim 1, integrated into the automated method, facilitating:
a) locating packs of linked tubes in the loading area and/or the SPAM building;
b) checking the status of DU and non-DU bins to determine if they are full;
c) precise gripping and transferring of ammunition from DU bin to the bowl feeder based on visual cues;
d) confirmation of successful transfer through feedback from each vision system;
e) verifying if any bins remain in the loading area;
f) continuous monitoring the feeding process and updating feeding status data to the control and management system.
